(19) United States
(12) Patent Application Publication
(10) Pub. No.: US 2011/0184837 A1
(43) Pub. Date: Jul. 28, 2011

(54) SYSTEM AND METHOD FOR ORDERING PRODUCTS AND MATERIALS USING AN ELECTRONIC SKU FINDER

(76) Inventor: Janos Biro, San Clemente, CA (US)

(21) Appl. No.: 12/692,647

(22) Filed: Jan. 24, 2010

(51) Int. Cl. G06Q 30/00; G06F 17/30; G06F 3/048; G06F 3/041

(52) U.S. Cl. 705/27.1; 707/722; 707/E17.108; 715/738; 715/702

(57) ABSTRACT

A programmed data control server compiles a database of product and materials order information from all available suppliers, allows users Internet access to search and order from the database and arrange for delivery or pickup, and inputs and tracks orders to selected suppliers via the Internet. Customers utilize a touch screen on a remote electronic device, which may be a handheld dedicated device exclusively connected to the data control server or other Internet connected device, to search the data control server, save desirable repeat order information, search for special offers, place orders, set up delivery or pickups, and track orders through the data control server.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to computer searching and ordering systems and in particular to a data control server programmed to create a database of all products available from all available suppliers in any given product category, the data control server further programmed to receive search inquiries, orders, and order tracking inquiries from users via an exclusive internet connection from a dedicated electronic device or any programmed electronic device via the Internet, and relay the orders and order tracking inquiries to selected suppliers to facilitate ordering supplies from a vendor, the system using an Electronic SKU Finder (eSF) software application in the data control server, which is programmed to allow remote users to perform products searches and save desired order information, place orders, arrange for pickup or delivery at a specific time, check order status, locate a nearest store, and find special offers available from vendors.

2. Description of Related Art Including Information Disclosed Under 37 CFR 1.97 and 1.98

Contractors and home owners spend countless hours at building supply stores, office supply stores, electronic stores and most types of large inventory stores searching for needed materials, searching for personnel to help in the process, placing orders, waiting for supplies, and checking out. This situation wastes time and money and creates frustration. The prior art has failed to come up with an adequate way of dealing with these problems.

U.S. Pat. No. 6,134,557, issued Oct. 17, 2000 to Freeman, is for a materials and supplies ordering system comprising a computer program which displays a number of objects in some form of organized, often hierarchial, fashion commonly known as a categorization table. In summary, the ordering program displays a categorization table organizes data under successive and expandable levels of categorized headings, assigns the appropriate vendor specific names, SKU codes, part numbers, universal product code, and/or bar codes, and then transfers this specific information to a merchant or vendor for processing of the order. The program allows the user to manipulate the data or to select objects for appropriate actions (starting a program, printing a construction material supply list, transferring a generated list(s) to the vendor/merchant, etc.). Once the categorization table is completed, a specific report can be generated from the program. This report is a material and supply list which details the vendor/merchant specific names, stock keeping unit (SKU) codes, vendor part numbers, universal product codes (UPC), and/or bar codes and quantity requested for each material listed on the table. This report also provides contractor identification information (name, address, telephone number) and specific job number, and accounting information (purchase order number or credit card number). Furthermore, this report is then transferred to the identified vendor/merchant for processing, and possible delivery of materials and supplies, including confirmation of the order.

U.S. Pat. No. 6,950,826, issued Sep. 27, 2005 to Freeman, provides a material and supplies ordering system and method for facilitating the ordering of construction supplies by a customer over the Internet. A contractor/customer ordering computer program product is shown, tangibly embodied on a machine-readable medium, comprising instructions operable to: initiate a contractor/customer ordering computer program; receive contractor/customer identification information entered by a contractor/customer in response to a display initiated by the ordering program; display a menu from which the contractor/customer selects a classification of construction materials or products, the classification associated with a construction phase; cause the contractor/customer to select a set of construction materials or products within the classification; display a set of specific material or product names corresponding to the selected set of construction materials or products, the set of specific material or product names being dependent on an identified regional supplier such that the set includes only names of specific materials or products that are offered by the identified supplier; in response to the contractor/customer selecting one or more of the displayed specific material or product names and a specific quantity desired for each selected specific material or product name, record the specific material or product name and a quantity for each specific material or product name selected; generate a list displaying the specific material or product name and the quantity for each specific material or product name selected; enable the contractor/customer to access at least one of a SKU number, a UPC, a bar code, or a material or product number for each individual material or product name selected; and cause data corresponding to the list and data pertaining to contractor/customer identification information entered into the ordering program to be submitted to the identified regional supplier.

U.S. Pat. No. 5,806,069, issued Sep. 8, 1998 to Wakiyama et al, shows a method and apparatus for totally managing sets of construction-related information relating to constructional relationship between each product to be produced and its component parts, and sets of production-related information relating to production of the products. The “construction-related information” for each working process of the parts of each product is reproduced on a suitable output medium in a predetermined format which includes not only identification codes or numbers of the parts of each product but also simple part drawings showing configurational features of the respective parts. The “production-related information” includes: data indicating the location of production of each part of each product (or location of production of the product); data indicating the manner, condition, procedure and other elements of the production of each part; data indicating the required characteristics or properties of each part to assure the quality of the part; data indicating the suppliers of each part; data indicating the purchase prince of each part; and data indicating the selling price of each part.

U.S. Patent Application #20070033108, published Feb. 8, 2007 by Luhr, puts forth systems and methods for tracking component-related information associated with buildings. A system is described for collecting, maintaining, and using information about construction, maintenance, and use features of buildings and their components. One or more building identifier tags affixed to a building during construction include a unique building identifier for the building and access information allowing a user to access a computer-implemented repository of information about the building. The repository may comprise information about components in the building, which may be identified in the repository by product identifiers, as well as information about component manufacturers, warranties, installation and maintenance instructions, information about workers associated with construction of the building, and quality checkpoints useful for checking and documenting the quality of construction for the building. The repository may also facilitate registration of warranties, transmission of safety and recall information associated with building components, targeted marketing of offers to residents of the building, as well as other communications amongst parties associated with the building.

U.S. Patent Application #20030158796, published Aug. 21, 2003 by Balent, concerns a distributed personal automation and shopping method, apparatus, and process. A business method is provided utilizing a system comprising one or more distributed computers, application software, off-the-shelf peripheral components including keyboard-and-mouseless data entry (KDE) devices, business processes, human and KDE device readable data, related information on removable data storage media or available from external databases, and existing communications systems for speeding and improving: 1) personal or business automation, efficiency and productivity, goal attainment; 2) improving, speeding and automating the person-computer interface; 3) selection, acquisition, and tracking usage of items acquired from an existing supply chain; 4) marketing items and retaining customers buying the products, controlling their usage, and disseminating information about the products. If the personal automation and shopping system is embodied for the construction industry, the Catalog & Cookbook 1k and the Removable Media 1h might contain building projects and instructions instead of cooking recipes and instructions.

U.S. Patent Application #20050102394, published May 12, 2005 by Loveland, illustrates automated task management and evaluation. Preferred embodiments incorporate a computer network to gather and disseminate information for the processes of embodiments of the invention. Task information is gathered until a task is sufficiently defined to be assigned. At this point the task is assigned to a service provider who is requested to respond to the assignment. The response is monitored arid if unacceptable or not received the task will be transferred to another service provider until a satisfactory response is received. An estimate of the cost of task completion may then be requested and authorization to complete the task may be contingent upon an acceptable estimate. Once a service provider is authorized to complete a task, the provider's progress is monitored and reported to interested parties. Provider quality ratings may be incorporated into some embodiments. Reports, analyses and other data may be automatically generated by embodiments of the invention. Applications of embodiments of the invention may be particularly useful in claims processing in the insurance industry.

U.S. Patent Application #20060224422, published Oct. 5, 2006 by Cohen, concerns a method for applying for insurance for a product at a point of sale. Cohen also mentions inventory sharing data with SKU numbers and also mentions that the product data may include one or more of the following: selling price, description, catalog number, quality, size, weight, color, construction materials, composition, specifications, manufacturer, trademark, manufacturer model identifier (e.g., model number), or any other data that may be pertinent to a customer's purchase of a good or product.

U.S. Patent Application #20020062258, published May 23, 2002 by Bailey et al, describes computer-implemented procurement of items using parametric searching. The computer-implemented method for procuring one or more items includes, in response to user-provided data and after user selection of a search module using a client system, providing an item category. Based on user selection of the item category using the client system, one or more attributes associated with all items in the item category are provided. Based on user input identifying an attribute value for at least one attribute, search results including one or more items matching the attribute value are generated. In response to user selection of a particular item from among the search results using the client system, an order request for the selected item is then generated.

U.S. Patent Application #20020091690, published Jul. 11, 2002 by Bailey et al, discloses a database system facilitating textual searching. A computer-implemented method for searching for a desired item includes, in response to user input specifying an alphanumeric string associated with a desired item, searching a database that comprises information associated with items for an alphanumeric string that matches the user-specified alphanumeric string to determine item names and item descriptions for all matching items corresponding to the matching alphanumeric string. The determined item names and item descriptions for the matching items are provided for display to the user. In response to user input indicating a desire to view attribute values for attributes of the particular matching item, attribute names and attribute values for attributes of the particular matching item are determined and provided for display to the user.

U.S. Pat. No. 7,502,787, issued Mar. 10, 2009 to Bailey et al, indicates a database system facilitating textual searching. The computer-implemented method for searching for a desired item includes, in response to user input specifying an alphanumeric string associated with a desired item, searching a database that comprises information associated with items for an alphanumeric string that matches the user-specified alphanumeric string to determine item names and item descriptions for all matching items corresponding to the matching alphanumeric string. The determined item names and item descriptions for the matching items are provided for display to the user. In response to user input indicating a desire to view attribute values for attributes of the particular matching item, attribute names and attribute values for attributes of the particular matching item are determined and provided for display to the user.

U.S. Pat. No. 7,330,852, issued Feb. 12, 2008 to Bailey et al, claims computer-implemented procurement of items using parametric searching. The computer-implemented method for procuring one or more items includes, in response to user-provided data and after user selection of a search module using a client system, providing an item category. Based on user selection of the item category using the client system, one or more attributes associated with: all items in the item category are provided. Based on user input identifying an attribute value for at least one attribute, search results including one or more items matching the attribute value are generated. In response to user selection of a particular item from among the search results using the client system, an order request for the selected item is then generated.

U.S. Pat. No. 6,820,076, issued Nov. 16, 2004 to Bailey et al, describes a database system facilitating parametric searching. The database may include a price of the corresponding item; descriptive information for the corresponding item; a unit of measure for the corresponding item; a quantity in which the corresponding item is sold; a stock keeping unit (SKU) for the corresponding item; a location for the corresponding item; and an identifier uniquely identifying the manufacturer of the corresponding item.

U.S. Pat. No. 6,249,773, issued Jun. 19, 2001 to Allard et al, concerns a method and an apparatus to automate consumer replenishment shopping using SKU numbers based off purchasing history. It is mentioned that the consumer may be a building contractor, who will need to purchase the same kinds of lumber, wallboard, fixtures, fasteners and other building materials for each house under construction.

U.S. Pat. No. 5,740,425, issued Apr. 14, 1998 to Povilus, illustrates a data structure and method for creating, maintaining, and publishing multiple renditions of both electronic and printed, single and multi-manufacturer catalogs using a single product database. Also disclosed is an electronic catalog created using the data structure and methodology of the invention. The data structure includes means for creating a product database and means for creating a KnowledgeBase, which includes a concept structure for at least one product realm and a glossary. The concept structure includes at least one concept frame for defining classes of product groupings, where the concept frames include a plurality of concept nodes having relationships based upon characteristics of the products within the product realm. The product database preferably includes a listing of SKUs, each SKU corresponding to a product or a component of a product. The product database further including product information for each associated SKU, and an identification of each concept node in which each SKU can be located. The glossary is used for searching for a particular product or group of products having desired characteristics, and includes a plurality of phrases, at least one of which being a definer that links the phrase to one of the concept nodes. A contractor usage scenario is provided.

U.S. Pat. No. 6,810,383, issued Oct. 26, 2004 to Loveland, discloses automated task management and evaluation. Preferred embodiments incorporate a computer network to gather and disseminate information for the processes of embodiments of the invention. Task information is gathered until a task is sufficiently defined to be assigned. At this point the task is assigned to a service provider who is requested to respond to the assignment. The response is monitored arid if unacceptable or not received the task will be transferred to another service provider until a satisfactory response is received. An estimate of the cost of task completion may then be requested and authorization to complete the task may be contingent upon an acceptable estimate. Once a service provider is authorized to complete a task, the provider's progress is monitored and reported to interested parties. Provider quality ratings may be incorporated into some embodiments. Reports, analyses and other data may be automatically generated by embodiments of the invention. Applications of embodiments of the invention may be particularly useful in claims processing in the insurance industry. Three U.S. patents, U.S. Pat. No. 7,130,814 issued Oct. 31, 2006; U.S. Pat. No. 6,965,871 issued Nov. 15, 2005 and U.S. Pat. No. 6,963,851 issued Nov. 8, 2005 to Szabo et al, put forth methods and apparatuses to automate consumer replenishment shopping using SKU numbers based off purchasing history. It is mentioned that the consumer may be a building contractor, who will need to purchase the same kinds of lumber, wallboard, fixtures, fasteners and other building materials for each house under construction.

What is needed is a system for setting up a database on a data control server for SKU (Stock Keeping Unit) numbers, photos and other order information for all available products from all available suppliers in any product category, which database is made available to users having a dedicated handheld electronic device with an exclusive Internet connection for connecting to the data control server or a personal computer or handheld device for connecting via the Internet so that the user can order desired products from remote locations, including at a work site, and have the ability to perform products searches, save repeat order information, place orders, arrange for pickup or delivery at a specific time, check order status, locate a nearest store, and view special offers available from suppliers.

### BRIEF SUMMARY OF THE INVENTION

An object of the present invention is to provide a system for setting up a database on a data control server for SKU (Stock Keeping Unit) numbers, photos and other order information for all available products from all available suppliers in any product category, which database is made available to users having a dedicated handheld electronic device with an exclusive Internet connection for connecting to the data control server or a personal computer or handheld device for connecting via the Internet so that the user can order desired products from remote locations, including at a work site, and have the ability to perform products searches, save repeat order information, place orders, arrange for pickup or delivery at a specific time, check order status, locate a nearest store, and view special offers available from suppliers.

In brief, the present invention provides a programmed data control server which compiles product and materials order information from all available suppliers and inputs and tracks orders to selected suppliers via the Internet. Customers utilize a program activating a touch screen on a remote electronic device, which may be a handheld dedicated device exclusively connected to the data control server or other Internet connected device, to search the data control server, save desirable repeat order information, search for special offers, place orders, set up delivery or pickups, and track orders through the data control server.

The hand held dedicated electronic order device of the present invention has large touch screen selection buttons and scroll bars and selection button in the frame around the touch screen for ease of usage. Whenever a form on the touch screen requires the user to enter or type in any data manually, a virtual alphanumeric keyboard or a numeric keyboard is displayed on the touch screen and is used to enter the data.

A Main Form on the touch screen consists of large main buttons, which are the shortcuts or selection buttons to main functions of the application.

A New Order Form on the touch screen is used to create a new order. If there is more than one vendor in the system, the touch screen allows the user to select the vendor to send the order form to before showing the order form. Once the vendor is selected, the selected vendor name is shown on the order form.

If a delivery option is selected, the present invention checks with the store if shipping is possible. This may have to be done when each product is added to the order. If delivery is possible, the form displays estimated delivery time and date.

A Product Search Form on the touch screen allows the user to search for a product by category, SKU number, photographs, drawings, or descriptions. A similar function is also used in the New Order form when adding products.

A Nearest Store Form on the touch screen lets the user set the zip code to locate the nearest supplier or vender stores.

A Specials Form on the touch screen displays a list of specials available from vendors.

An advantage of the present invention is that it expedites materials ordering and delivery or pickup without wasting time searching a store.

Another advantage of the present invention is that the ordering and checking of the order takes place remotely to save time and travel for a user.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view of the physical components of the materials acquisition system of the present invention;

FIG. 2 is a diagrammatic view of a flow chart of the product and supplier information inputting step of the materials acquisition system of the present invention;

FIG. 3 is a diagrammatic view of a flow chart of a product search phase of the materials acquisition system of the present invention;

FIG. 4 is a diagrammatic view of a flow chart of a product order phase of the materials acquisition system of the present invention;

FIG. 5 is a diagrammatic view of a flow chart of the order status process of the materials acquisition system of the present invention;

FIG. 6 is a front elevational view the dedicated hand-held programmed remote ordering device of the materials acquisition system of the present invention showing the control button display screen;

FIG. 7 is a front elevational view the dedicated hand-held programmed remote ordering device of the materials acquisition system of the present invention showing the product search form screen;

FIG. 7A is a front elevational view the dedicated hand-held programmed remote ordering device of the materials acquisition system of the present invention showing the product search form screen including a picture;

FIG. 8 is a front elevational view the dedicated hand-held programmed remote ordering device of the materials acquisition system of the present invention showing the product order form screen;

FIG. 9 is a front elevational view the dedicated hand-held programmed remote ordering device of the materials acquisition system of the present invention showing the alphanumeric keyboard input screen;

FIG. 10 is a front elevational view the dedicated hand-held programmed remote ordering device of the materials acquisition system of the present invention showing the calculator keyboard screen.

### DETAILED DESCRIPTION OF THE INVENTION

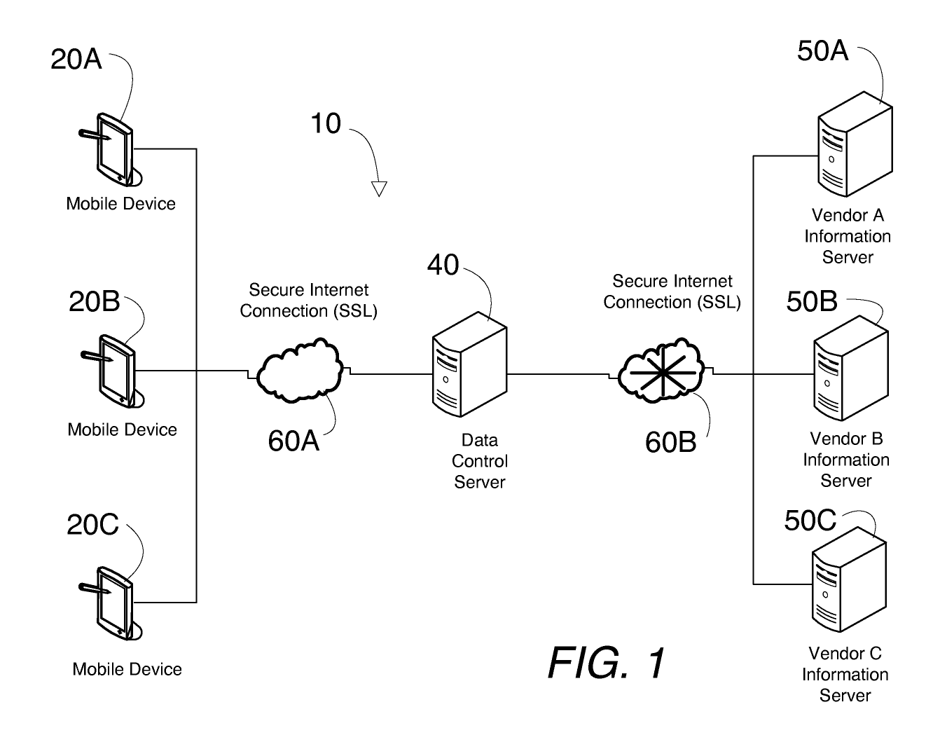

In FIGS. 1-10, a materials acquisition system 10 and method 100, 200, 300, 400 comprise a data control server 40 that communicates with electronic order devices (EOD) 20A, 20B, 20C and suppliers' servers 50A, 50B, 50C through secure Internet connections 60A, 60B, as shown in FIG. 1. The data control server 40 has hardware and programmable software for acquiring ordering information for products and materials from all available suppliers of the products and services and for compiling and storing a searchable database containing the ordering information, the availability of the products and materials, and locations of the suppliers of the products and services. The data control server places and tracks orders and deliveries or pickups with selected suppliers after a customer places an order with the data control server.

The programmable software on the data control server includes an electronic SKU finder (eSF), which comprises a software application that allows the user to create an order and submit it to a vendor of choice via the data control server for faster and more accurate order processing. The eSF application retrieves data from the data control server that communicates with vendor services, using SKU (Stock Keeping Unit) numbers for the products and services or product photographs or other search capabilities. Lists of products may be retrieved and saved on the data control server as XLM files, which will be used as the database of products. The data control server 40, is deployed to control the communication between the Electronic Ordering Devices (EODs) 20A, 20B, 20C and suppliers' servers 50A, 50B, 50C.

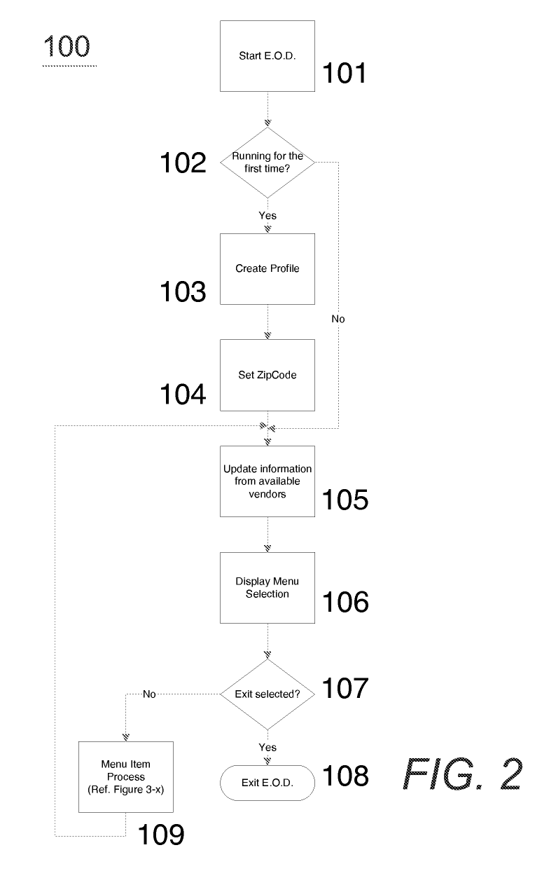

In FIGS. 2-5, the materials acquisition system method 100, 200, 300, 400 comprises acquiring ordering information for products and materials from all available suppliers of the products and services and compiling and storing the ordering information for the products and materials in a searchable database in a data control server comprising hardware and programmable software. The data control server communicates with the suppliers through a secure Internet connection. The searchable ordering information includes SKU numbers, product lists and descriptions, prices, product photographs or drawings, availability of the products and materials, and locations of the suppliers of the products and services.

The data control server 40 of the system allows controlled access to the searchable database by a customer using a remote electronic device, which may be a dedicated remote hand held electronic device with an exclusive Internet connection to the data control server, preferably a wireless connection, or other programmed device connected to the Internet to use the data control server eSF program using SKU numbers to search and order desired products and materials from at least one selected supplier from all the available suppliers or using photographs or other descriptions in searching and ordering, to save desired repeat product information, to arrange pickup or delivery of the ordered products and services, and to track an order through the data control server via the Internet.

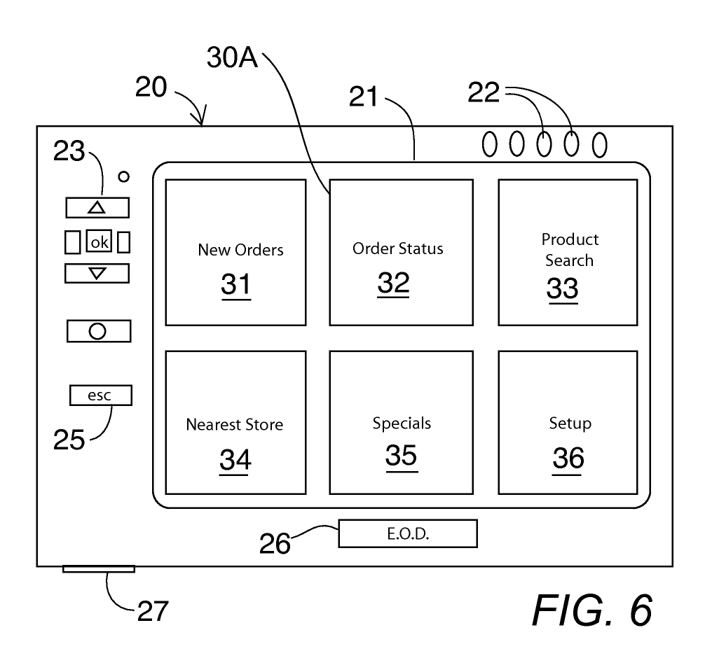

The steps of searching and ordering and arranging pickup and delivery and tracking an order may be accomplished using an interactive touch screen 21 on a dedicated hand held electronic order device (E.O.D.) 20 with an exclusive Internet connection to the data control server, as shown in FIGS. 6-10, or other programmed device with an Internet connection, such as a laptop computer, smart-phone, or PDA with an Internet connection and the capability to run third party software programs.

In FIG. 2, the Application Overview flow chart shows the process of the initial setup of the communication between the Electronic Ordering Device (EOD) with the data control server. The program begins with Start EOD 101, and proceeds to “Running for the First Time?” 102. If true, the program proceeds to Create a Profile 103, Set Zip Code 104, and then Update Information from Available Vendors 105. If “Running for the First Time?” 102 is false, the program skips to Update Information from Available Vendors 105, then Display Menu Selections 106. At this point, a choice is made whether to exit the program or not 107. If Exit is chosen, the program proceeds to Exit EOD 108. If Exit is not chosen, the program proceeds to the Menu Item Process 109.

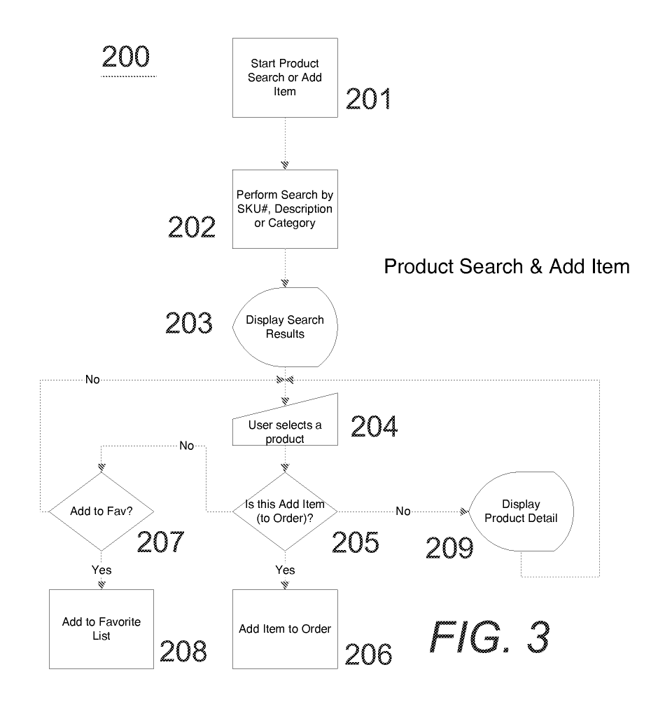

In FIG. 3, the Product Search and Add Item flow chart 200 begins with Start Product Search or Add Item 201. The program proceeds to Perform Search 202, using SKU number, description, or category. Once the search is complete, the program displays the search results 203. A product is selected 204, from the search results, which leads to Add Item to Order 205. If true, the program proceeds to Add Item to Order 206. If false, the program proceeds to Display Product Detail 209, which leads to the step, Add to Favorites 207. If true, the program proceeds to Add to Favorites List, 208.

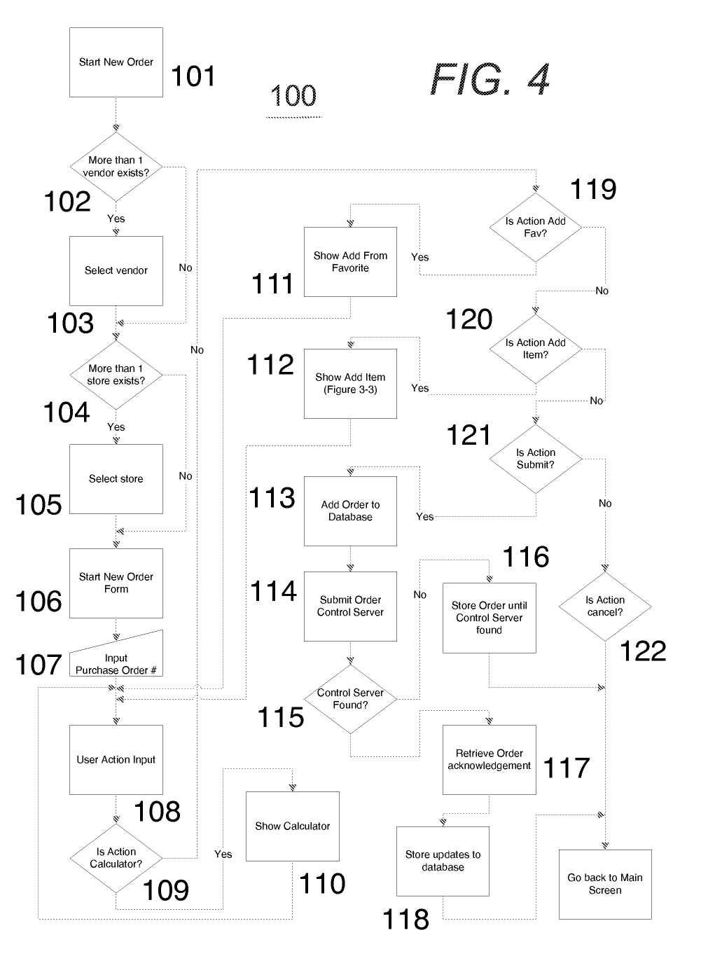

In FIG. 4, the New Order flow chart 300, begins with Start New Order 301, and proceeds to selection or store and vendor or supplier 302-305, searching for items and ordering 306-322, including saving items for reordering (Add to Favorites) 311 and 319.

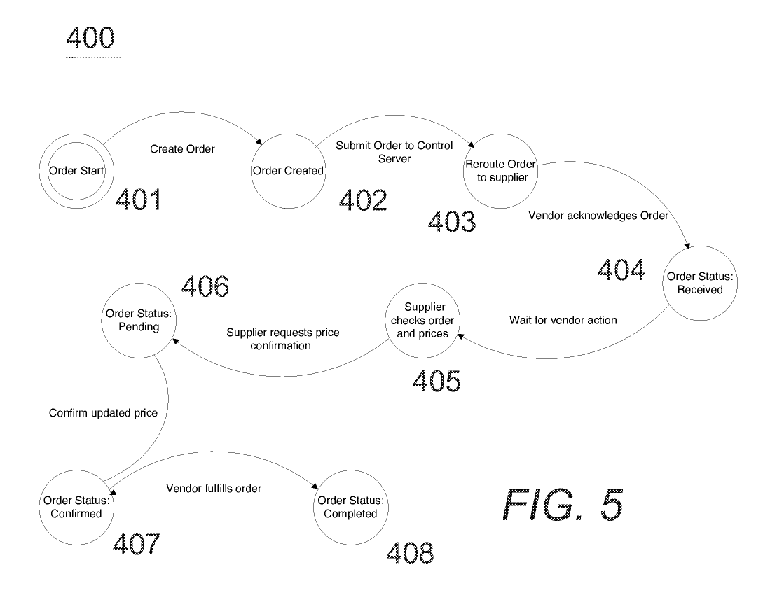

In FIG. 5, the Order Status Process flow chart 400 begins with Order Start 401. Creating the order proceeds to Order Created 402. Submitting the order leads to Reroute Order to Supplier 403, whereupon the supplier/vendor acknowledges the Order returning the order status: Received 404. The users waits for supplier/vendor action while the Supplier/Vendor checks the order and prices 405. The supplier/vendor requests price confirmation, returning the order status: Pending 406. The updated price is confirmed returning the order status: Confirmed 407. The supplier/vendor fulfills the order returning the order status: Completed 408.

In FIGS. 6-10, a dedicated handheld remote Electronic Ordering Device (EOD) 20 has an exclusive connection via the Internet to the data control server, preferably a wireless connection (which may use VWFI, 3G, 4G, Bluetooth, or other wireless technology), that lets a user perform materials acquisition remotely over the Internet using SKU (Stock Keeping Unit) numbers or other order numbers or product information or product images for the products and services.

The EOD 20 has a housing which contains manual controls 23, 25, 24, a port 27 for receiving a memory card, indicator lights 22, a logo 26, and an interactive touch screen display 21, allowing the user to proceed through the steps of materials acquisition including the product search, ordering, and tracking The manual controls include scrolling and selection buttons 23, an on/off button 24, and an escape button 25. In a preferred embodiment, the mobile device is a dedicated, hand-held, electronic device with an exclusive internet connection to the data control server. It may also be a smart-phone or other Internet accessible electronic device, such as a PDA, connecting to the data control server via the Internet.

In FIG. 6, the touch screen 21 initially displays the main ordering window 30A, which offers the following touch screen large button choices: New Orders 31, Order Status 32, Product Search 33, Nearest Store 34, Specials 35, and Setup 36. Pressing one of these touch screen buttons leads to the steps involved with the process associated with that button.

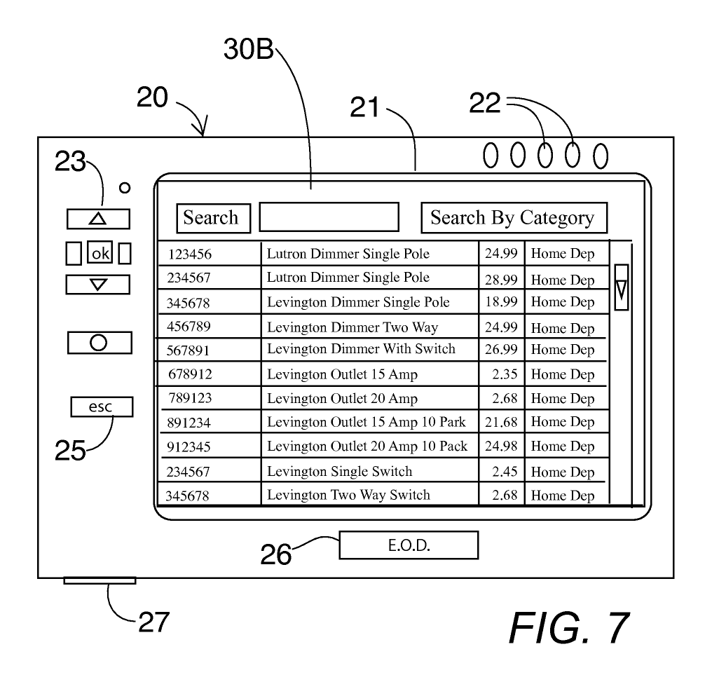

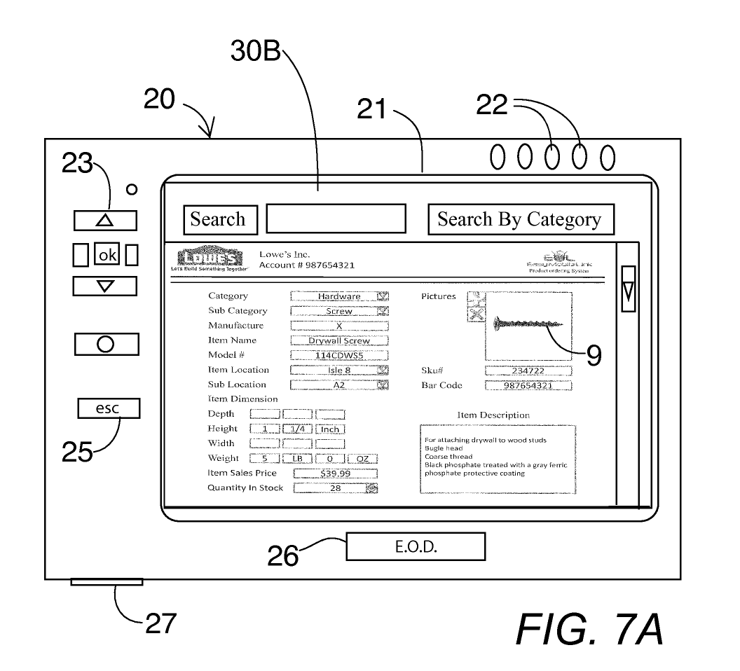

In FIG. 7, the touch screen 21 displays an interactive search form screen 30B, wherein the user may enter search criteria to locate a particular item or service, and choose a particular vendor, or a particular store at which the item or service is sold. The user may search either by using keywords, or categories, preferably SKU numbers. By selecting an item on the list, the user may view the products details of that item, or choose to add the item to the order. In FIG. 7A, the touch screen 21 displays an interactive search form screen 30B, wherein the user may enter search criteria to locate a particular item or service including illustrations 9 of the product, such as photos or drawings of the product.

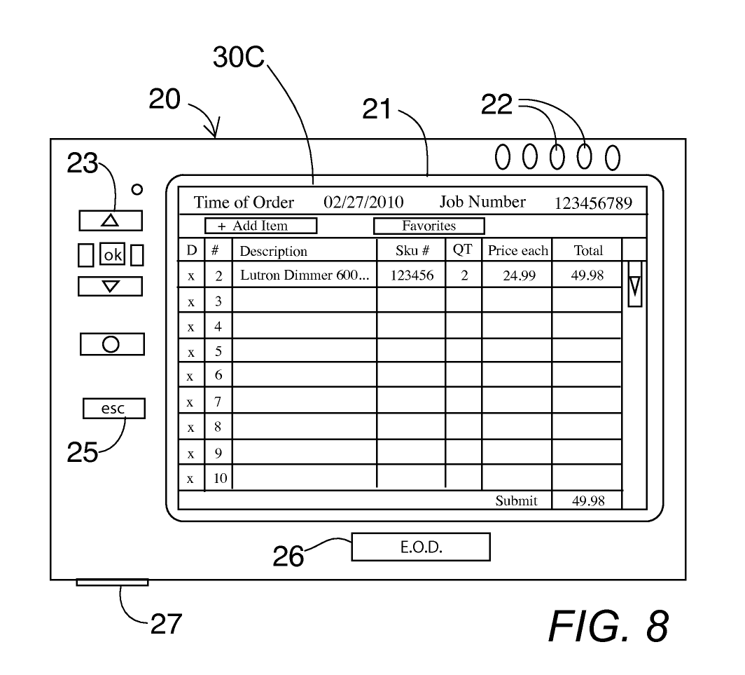

In FIG. 8, the touch screen 21 displays an interactive order form screen 30C, which allows the user to add an item to the order and/or add an item to the user's Favorites List, a list maintained in the user's profile, which provides for speedy access to frequently used items.

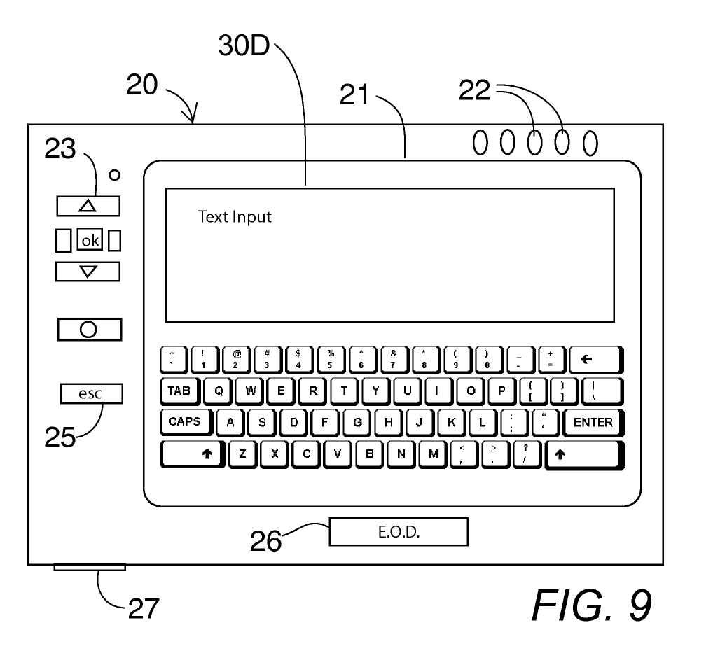

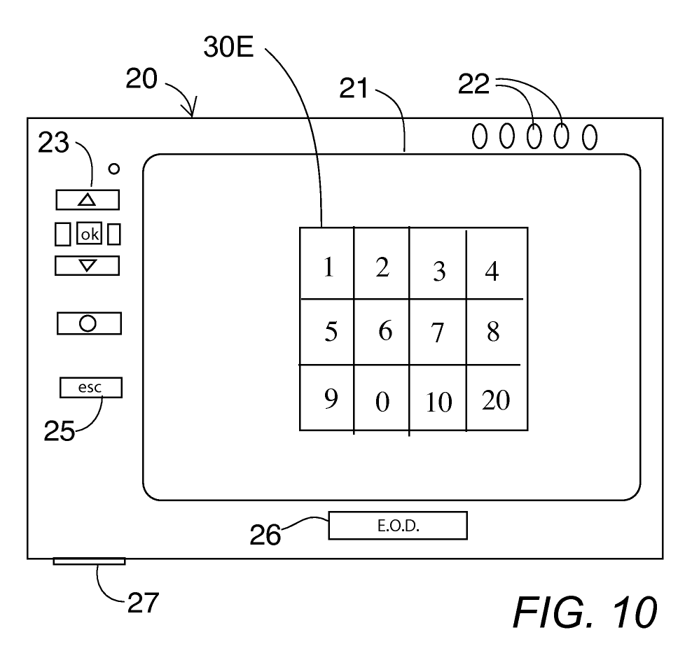

In FIG. 9, the touch screen 21 displays an interactive alphanumeric keyboard input screen 30D for inputting information to the order form or search words to the search form. In FIG. 10, the touch screen 21 displays an interactive calculator input screen 30E for calculating prices based on number of units ordered. The interactive keyboard input screen 30D and the interactive calculator input screen 30E are accessed when a user taps an input field on the touch screen, such as the keyword search field on the interactive search form screen 30B, shown in FIG. 7.

A user connects to the data control server via a dedicated hand held Electronic Order Device 20 using an exclusive Internet connection or any other electronic device connecting to the Internet to perform all of the functions in the product acquisition process.

The present system and method may be used in any purchasing transactions and is especially useful in situations where large sales outlets have extensive inventory and require considerable time for users to search out and make purchases, including sale of building products and materials, electronic equipment, software, computers, cell phones, consumer goods, food, prepared food (as in restaurants), or any other sales situation that is time consuming or requires travel and waiting for users.

It is understood that the preceding description is given merely by way of illustration and not in limitation of the invention and that various modifications may be made thereto without departing from the spirit of the invention as claimed.

What is claimed is:

1. A materials acquisition system comprising:
a data control server comprising hardware and programmable search and acquisition software for connecting to supplier software via a secure Internet connection to acquire ordering information for products and materials from all available suppliers of the products and services and for compiling and to store in the data control server a searchable database containing ordering information for the products and materials, availability of the products and materials, and locations of the suppliers of the products and services; the data control server further comprising programmable access software for allowing access to the searchable database via a secure Internet connection to users using remote hand held electronic devices having exclusive connections to the data control server and to users using electronic devices having Internet browsing connections to enable users to search and order desired products and materials from at least one selected supplier, to arrange pickup or delivery of the ordered products and services, to track an order, to save information for reordering, and to search for special offers; the data control server further comprising programmable ordering and tracking software for communicating user ordering and delivery or pickup information to the at least one supplier and to obtain tracking information from the at least one supplier to communicate to the users.

2. The system of claim 1 wherein the searching and ordering information comprises SKU (Stock Keeping Unit) numbers for the products and services.

3. The system of claim 1 wherein the remote hand held electronic devices having exclusive connections to the data control server each use wireless technology.

4. The system of claim 3 wherein the remote hand held electronic devices each comprise a housing having an interactive touch screen which displays an interactive control button screen including a product search button, a nearest store finder button, a special offer finder button, a new order button, an order status button, and a set up button.

5. The system of claim 4 wherein the touch screen display further comprises an interactive search form screen, an interactive order form screen, an interactive keyboard input screen, and an interactive calculator input screen.

6. A materials acquisition method comprising:
a first step of connecting a data control server, comprising hardware and programmable search and acquisition software, to supplier software via a secure Internet connection to acquire ordering information for products and materials from all available suppliers of the products and services;
a second step of using the hardware and programmable search and acquisition software for compiling and storing in the data control server a searchable database containing ordering information for the products and materials, availability of the products and materials, and locations of the suppliers of the products and services;
a third step of using programmable access software for allowing access to the searchable database via a secure Internet connection to users using remote hand held electronic devices having exclusive connections to the data control server and to users using electronic devices having Internet browsing connections to enable users to search and order desired products and materials from at least one selected supplier, to arrange pickup or delivery of the ordered products and services, to track an order, to save information for reordering, and to search for special offers;
a fourth step of using a programmable ordering and tracking software for communicating user ordering and delivery or pickup information to the at least one supplier; and
a fifth step of using the programmable ordering and tracking software for obtaining tracking information from the at least one supplier and communicating the tracking information to the users.

7. The method of claim 6 wherein the third and fourth steps comprise using SKU (Stock Keeping Unit) searching software.

8. The method of claim 6 wherein the third, fourth, and fifth steps comprise a user using an interactive touch screen on an electronic communication device to perform materials acquisition remotely over the Internet using wireless technology.

9. The method of claim 8 wherein the third, fourth, and fifth steps comprise a user using a portable hand-held dedicated electronic device comprising a housing having a touch screen which displays an interactive control button screen including a product search button, a nearest store finder button, a special offer finder button, a new order button, an order status button, and a set up button.

10. The method of claim 9 wherein the third, fourth, and fifth steps comprise a user using the touch screen display comprising an interactive search form screen, an interactive order form screen, an interactive keyboard input screen, and an interactive calculator input screen.
